(19) United States
(12) Patent Application Publication
(10) Pub. No.: US 2006/0101364 A1
(43) Pub. Date: May 11, 2006

(54) Method and apparatus for data distribution in a high speed processing unit

(75) Inventors: Sang Hoo Dhong, Austin, TX (US); Hiroaki Murakami, Austin, TX (US); Shohji Onishi, Shiga-ken (JP); Osamu Takahashi, Round Rock, TX (US)

Correspondence Address: IBM CORPORATION (CS);C/O CARR LLP, 670 FOUNDERS SQUARE, 900 JACKSON STREET, DALLAS, TX, 75202, US

(73) Assignees: International Business Machines Corporation, Armonk, NY (US); Toshiba America Electronic Components, Inc, Irvine, CA (US); Kabushiki Kaisha Toshiba, Tokyo (JP)

(21) Appl. No.: 10/965,625

(22) Filed: Oct. 14, 2004

(51) Int. Cl. G06F 17/50

(52) U.S. Cl. 716/7

(57) ABSTRACT

A method, an apparatus, and a computer program are provided for distributing data in a high speed processing unit. Traditionally, true readout data from multiport register files are inverted multiple times when transmitting the readout to data latches, located at multiple physical layers. The inversion of the readout data can be boost the signals and provide the proper true or complement data to the data latches. To reduce the number of inverters, the register files are configured to output true and complement signals. Therefore, power consumption and area are reduced with the elimination of the inverters.

### FIELD OF THE INVENTION

The present invention relates generally to data distribution, and more particularly, to distributing data more efficiently in a high speed Processing Unit (PU).

### DESCRIPTION OF THE RELATED ART

In conventional PUs, data generally flows from a multiport register file to data latches within different macros. Typically, the multiport register output either all True or all Compliment readout data signals to the various macros. During the process of transferring data to the different macros, the signals can be, and usually are, inverted one or more times. The inverters are often used to drive the readout data along the long data lines that exist between the multiport register and the various macros. The number of inverters between the multiport register file and a macro, therefore, varies according to the distance between the register file and the macro. The inverters can also be used to invert the signal purposefully, depending on the input requirements of the macro.

As an example, FIG. 1 is an illustration of a conventional data distribution system for a high speed PU. Referring to FIG. 1 of the drawings, the reference numeral 100 generally designates a conventional data distribution system for a high speed PU. The distribution system 100 comprises a multiport register file 102, a first macro 104, a second macro 106, a third macro 108, a fourth macro 110, and a fifth macro 112.

The system 100 operates by distributing True readout data to the various macros from the register file 102. The first macro 104 comprises a first data latch 114 that receives data from the first port (not labeled) of the register file 102 without inversion. The second macro 106 comprises a second data latch 116. The second data latch 116 receives readout data from the second port (not labeled) of the register file 102; however, the readout data from the second port (not labeled) is inverted twice through a first inverter 134 and a second inverter 142. Hence, the readout data from the second port (not labeled) is an identical, True signal output from the second port (not labeled), which has been driven along the data line to the second data latch 116.

The third macro 108 is more complicated than the first macro 104 and the second macro 106 because of the input signal demands and the number of its internal data latches. A third data latch 118 and a fourth data latch 120 comprise the third macro 108. The third data latch 118 receives readout data from the third port (not labeled) of the register file 102, which is inverted four times. The readout data from the third port (not labeled) is inverted by a third inverter 132, a fourth inverter 140, a fifth inverter 150, and a sixth inverter 152. Hence, the readout data from the third port (not labeled) is an identical, True signal output from the third port (not labeled), which has been driven along the data line to the third data latch 118. The fourth data latch 120 receives readout data from the fourth port (not labeled) of the register file 102, which is inverted four times. The readout data from the fourth port (not labeled) is inverted by a seventh inverter 130, an eighth inverter 138, a ninth inverter 148, and a tenth inverter 146. Hence, the readout data from the fourth port (not labeled) is an identical, True signal output from the fourth port (not labeled), which has been driven along the data line to the fourth data latch 120. Additionally, the fourth macro 110, on the other hand, does not receive readout data from the register file 102, even though the fourth macro 110 comprises a fifth data latch 122.

In comparison to third macro 108, the fifth macro 112 is equally as complicated. A sixth data latch 124 and a seventh data latch 126 comprise the fifth macro 112. The sixth data latch 124 receives readout data from the fourth port (not labeled) of the register file 102, which is inverted six times. The readout data from the fourth port (not labeled) is inverted by the seventh inverter 130, the eighth inverter 138, the ninth inverter 148, an eleventh inverter 156, a twelfth inverter 160, and a thirteenth inverter 164. Hence, the readout data from the fourth port (not labeled) is an identical, True signal output from the fourth port (not labeled), which has been driven along the data line to the sixth data latch 124. The seventh data latch 126 receives readout data from the fifth port (not labeled) of the register file 102, which is inverted six times. The readout data from the fifth port (not labeled) is inverted by a fourteenth inverter 128, a fifteenth inverter 136, a sixteenth inverter 144, a seventeenth inverter 154, an eighteenth inverter 158, and a nineteenth inverter 162. Hence, the readout data from the fifth port (not labeled) is an identical, True signal output from the fourth port (not labeled), which has been driven along the data line to the seventh data latch 126.

During the process of transferring data from the multiport register file 102 to various data latches within macros, the signal is inverted several times. Some inversions are necessary for the input of a macro depending on the data input requirements for the macro. However, each time an inversion takes place, the data is delayed slightly and power is utilized. Additionally, each inverter requires a certain amount of silicon area. Therefore, there is a need for a method and/or apparatus for reducing the number of inverters in a PU data distribution system that addresses at least some of the problems associated with conventional data distribution systems.

### SUMMARY OF THE INVENTION

The present invention provides a method, an apparatus, and a computer program for distributing data in high-speed processors. The distribution system employs a multiport register file to output readout data to recipient macro. The readout data is configured to be true and complement. Once the true or complement data is generated, the recipient macros can retrieve the readout data directly, through a even number of inverters, or through an odd number of inverters. However, due to the output of both true and complement signals from the multiport register file, the overall number of inverters can be reduced.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a conventional data distribution system in a PU;

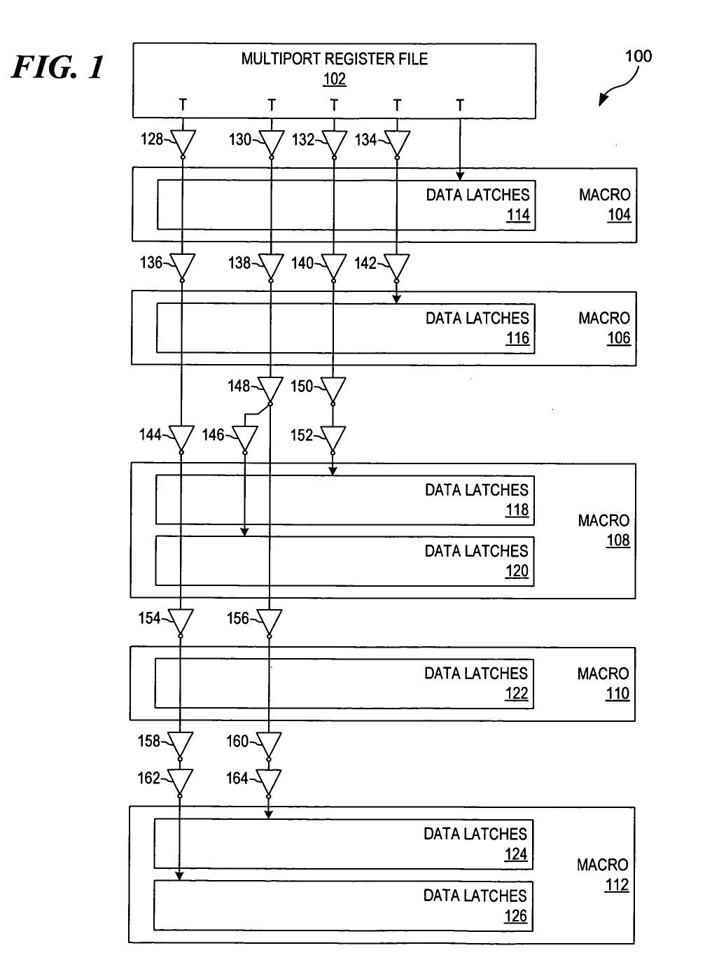

FIG. 2 is a block diagram depicting a modified data distribution system in a PU; and

FIG. 3 is a flow chart depicting data distribution in a high speed processor.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

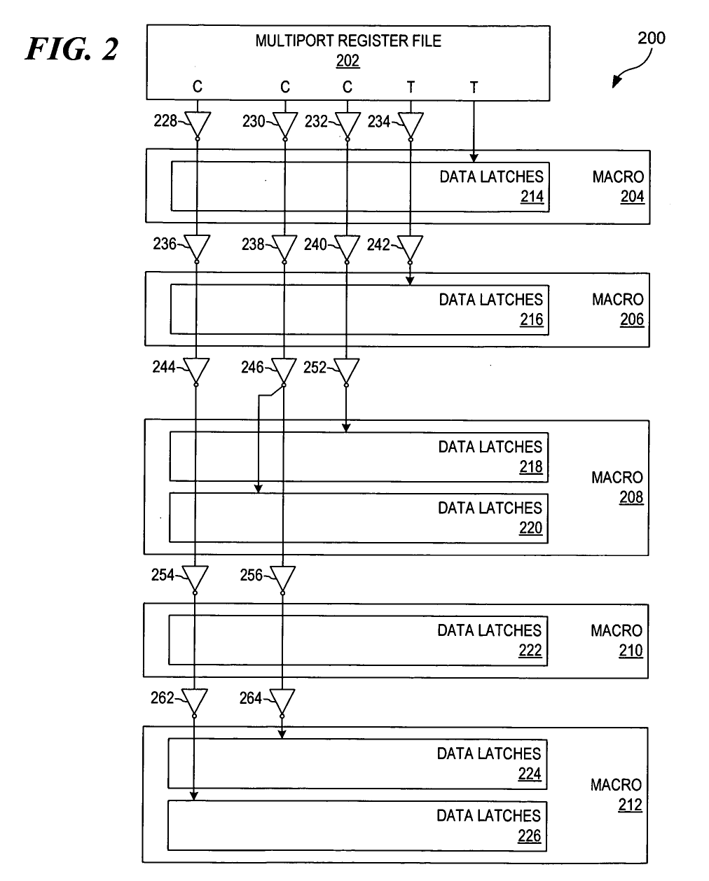

Referring to FIG. 2 of the drawings, the reference numeral 200 generally designates a modified data distribution system in a PU. The distribution system 200 comprises a multiport register file 202, first macro 204, a second macro 206, a third macro 208, a fourth macro 210, and a fifth macro 212.

The system 200 operates by distributing both True and Complement readout data to the various macros from the register file 202. The first macro 204 comprises a first data latch 214 that receives data from the first port (not labeled) of the register file 202 without inversion. The second macro 206 comprises a second data latch 216. The second data latch 216 receives readout data from the second port (not labeled) of the register file 202; however, the readout data from the second port (not labeled) is inverted twice through a first inverter 234 and a second inverter 242. Hence, the readout data from the second port (not labeled) is an identical, True signal output from the second port (not labeled), which has been driven along the data line to the second data latch 216.

The third macro 208 is more complicated than the first macro 204 and the second macro 206 because of the input signal demands and the number of its internal data latches. A third data latch 218 and a fourth data latch 220 comprise the third macro 208. The third data latch 218 receives readout data from the third port (not labeled) of the register file 202, which is inverted three times. The readout data from the third port (not labeled) is inverted by a third inverter 232, a fourth inverter 240, and a fifth inverter 252. Hence, the readout data from the third port (not labeled) is a True signal, which is the inverted, Complement output third port (not labeled). The fourth data latch 220 receives readout data from the fourth port (not labeled) of the register file 202, which is inverted three times. The readout data from the fourth port (not labeled) is inverted by a sixth inverter 230, a seventh inverter 238, and an eighth inverter 246. Hence, the readout data from the fourth port (not labeled) is a True signal output, which is the inverted, Complement output fourth port (not labeled). Additionally, the fourth macro 210, on the other hand, does not receive readout data from the register file 202, even though the fourth macro 210 comprises a fifth data latch 222.

In comparison to third macro 208, the fifth macro 212 is equally as complicated. A sixth data latch 224 and a seventh data latch 226 comprise the fifth macro 212. The sixth data latch 224 receives readout data from the fourth port (not labeled) of the register file 202, which is inverted five times. The readout data from the fourth port (not labeled) is inverted by the sixth inverter 230, the seventh inverter 238, the eighth inverter 246, a ninth inverter 256, and a tenth inverter 264. Hence, the readout data from the fourth port (not labeled) is a True signal, which is the inverted, Complement output fourth port (not labeled). The seventh data latch 226 receives readout data from the fifth port (not labeled) of the register file 202, which is inverted five times. The readout data from the fifth port (not labeled) is inverted by an eleventh inverter 228, a twelfth inverter 236, a thirteenth inverter 244, a fourteenth inverter 254, and a fifteenth inverter 262. Hence, the readout data from the fifth port (not labeled) is a True signal, which is the inverted, Complement output fifth port (not labeled).

From the modified distribution system 200, it is clear that the number inverters have been reduced. The reduction of the number of inverters reduces the overall power consumption and reduces propagation delay as a result of the inverters. Also, the amount of silicon area required by inverters, which have been removed, is preserved for other components. It is also possible to have a data latch that requires a Complement input instead of a True, which means that there an odd or even number of inverters based on whether the register file outputs a True or Complement output from a port.

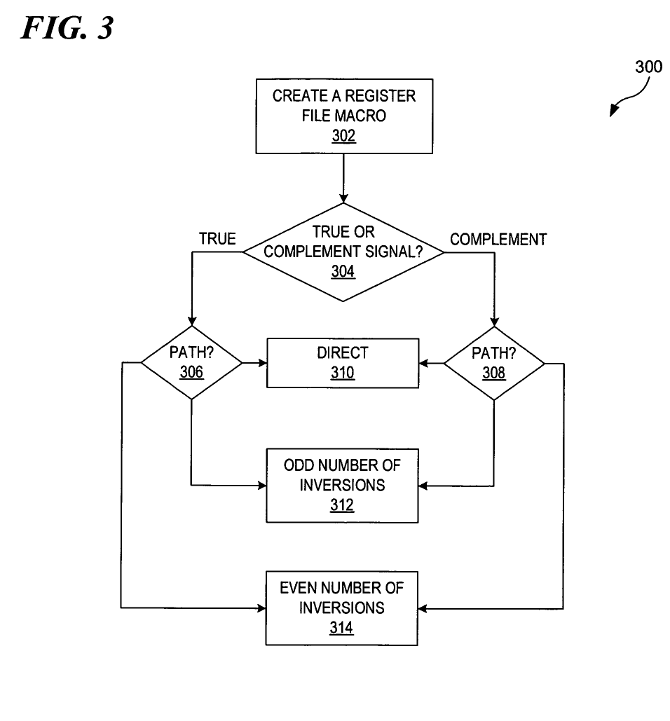

Referring to FIG. 3 of the drawings, the reference number 300 generally designates a flow chart that depicts data distribution in a high speed processing unit.

In step 302, a register file macro is created. In creating the register file macro, both true and complement signals are generated for specified data ports within a multiport register file in step 304. These different data port then can output true or complement data based on the port setting.

Once the signals have been generated for the different ports, the signals are then output to the various data latches. Depending on various settings, the data latched can either require true or complement signals. Also, depending on the distance that a data signal may have to travel, inverters may be employed to boost the signal. Hence, in steps 306 and 308, paths are chosen for true and complement signals, respectively.

There are three paths that can be chosen, a direct path, a path through an odd number of inverters, or a path through an even number of inverters. If the path is short and the data latch requires the specific true or complement signals output by the register file macro, then a direct path is chosen in step 310. If the latch required a inverted signal from the output of the register macro file, then a path with an odd number of inversions is chosen in step 312. If the path is long and the data latch requires the specific true or complement signals output by the register file macro, then a path with an even number of inversions is chosen in step 314.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method for distributing data for high-speed processors having a multiport register file, comprising:
generating readout data from the register file macro, wherein the readout data is at least configured to be true or complement; and
executing an action with a recipient macro in response to the register file macro from a group comprising:
retrieve the readout data directly from the register file macro;
retrieve the readout data from the register file with an odd number of inverters; and
retrieve the readout data from the register file with an even number of inverters.

2. The method of claim 1, wherein the step of generating further comprises:
generating true readout data for a first set of ports; and
generating complement readout data for a second set of ports.

3. The method of claim 1, wherein the method further comprises providing a plurality of recipient macros, wherein each recipient macros is at least configure to receive the readout data.

4. The method of claim 3, wherein the method further comprises receiving readout data directly by at least one recipient macro of the plurality of recipient macros.

5. The method of claim 3, wherein the method further comprises receiving readout data through an odd number of inverters by at least one recipient macro of the plurality of recipient macros.

6. The method of claim 3, wherein the method further comprises receiving readout data through an even number of inverters by at least one recipient macro of the plurality of recipient macros.

7. An apparatus for distributing data for high-speed processors, comprising:
a multiport register file that is at least configured to output readout data that is configured to be true readout data or complement readout data;
a plurality of inverters that are configured to invert the readout data; and
a plurality of recipient macros for receiving:
the readout data directly from the register file macro;
the readout data from the register file with an odd number of inverters; and
the readout data from the register file with an even number of inverters.

8. The apparatus of claim 7, wherein the multiport register file further comprises:
a first set of ports to generate true readout data; and
a second set of ports to generate complement readout data.

9. The apparatus of claim 7, wherein the apparatus further comprises at least one recipient macro of the plurality of recipient macros is at least configured to receive the readout data directly.

10. The apparatus of claim 7, wherein the apparatus further comprises at least one recipient macro of the plurality of recipient macros is at least configured to receive the readout data through an odd number of inverters.

11. The apparatus of claim 7, wherein the apparatus further comprises at least one recipient macro of the plurality of recipient macros is at least configured to receive the readout data through an even number of inverters.

12. A computer program product for distributing data for high-speed processors having a multiport register file, the computer program having a medium with a computer program embodied thereon the computer program comprising:
computer code for generating readout data from the register file macro, wherein the readout data is at least configured to be true or complement; and
computer code for executing an action with a recipient macro in response to the register file macro from a group comprising:
retrieve the readout data directly from the register file macro;
retrieve the readout data from the register file with an odd number of inverters; and
retrieve the readout data from the register file with an even number of inverters.

13. The computer program product of claim 12, wherein the step of generating further comprises:
computer code for generating true readout data for a first set of ports; and
computer code for generating complement readout data for a second set of ports.

14. The computer program product of claim 12, wherein the computer program product further comprises computer code for providing a plurality of recipient macros, wherein each recipient macros is at least configure to receive the readout data.

15. The computer program product of claim 14, wherein the computer program product further comprises computer code for receiving readout data directly by at least one recipient macro of the plurality of recipient macros.

16. The computer program product of claim 14, wherein the computer program product further comprises computer code for receiving readout data through an odd number of inverters by at least one recipient macro of the plurality of recipient macros.

17. The computer program product of claim 14, wherein the computer program product further comprises computer code for receiving readout data through an even number of inverters by at least one recipient macro of the plurality of recipient macros.
